(19) United States
(12) Patent Application Publication
(10) Pub. No.: US 2007/0178253 A1
(43) Pub. Date: Aug. 2, 2007

(54) FIBER GLASS AND STONE COMPOSITE DECORATIVE BOARD

(76) Inventor: Zhenyi Guo, Quanzhou City (CN)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/613,425

(22) Filed: Dec. 20, 2006

Related U.S. Application Data
(60) Provisional application No. 60/743,078, filed on Dec. 26, 2005.

(51) Int. Cl. B44F 7/00

(52) U.S. Cl. 428/15

(57) ABSTRACT

The present disclosure relates to a fiber glass and stone composite decorative board used for decorating constructive walls. The fiber glass and stone composite decorative board comprises a stone board which has a fiber glass web adhered to its backside. The fiber glass and stone composite decorative board has good flexibility, high intensity, impact resistance and light weight. It has notable advantage which is the resistance to the destructive pressure of wind to the decorative surface of external wall of high building. The significance of the invention is saving the nature resource, lightening the labor intensity, increasing the production rate, reducing the cost of production, and so on.

### CROSS REFERENCE TO RELATED APPLICATIONS

This application claims the benefit of U.S. Provisional Application Ser. No. 60/743,078 filed Dec. 26, 2005 which is hereby incorporated by reference in its entirety.

### TECHNICAL FIELD

The present disclosure relates generally to a decorative board used for building surface, and more particularly, it relates to a fiber glass and stone composite decorative board used for the external wall of building.

### BACKGROUND

An external wall decorative board used for building is usually the molded board with thickness of above 2 cm processed from the original stone, one surface of the board is polished into decorative face; the great deadweight of the original stone decorative board makes it difficult to carry, load and unload; the construction labor intensity is high, and the weight added to the building will destruct the basic structure of the building itself, on the other hand, it wastes the nature resource. So the cost associated with this type of construction has limited its use in commercial applications. To solve the said problem, the original stone may be thinned to be below 1 cm, however, because most stone is fragile, the high percentage of damage of the ultra thin board during the carrying, unloading and construction results in waste of the resource. The deadweight of the building decorated with the stone decorative board increases, moreover, the bond strength between the board and the wall will reduce because of the gravity of the board itself which make the board tend to move off the wall, the board also will fall because the pressure of the wind. So the stone decorative board with the single structure needs to be improved.

### SUMMARY

In order to overcome the above-indicated problems, the object of the present disclosure is to provide a fiber glass and stone composite decorative board which has such advantages as good flexibility, high intensity, impact resistance and light weight.

According to the object of the present invention, there is provided a fiber glass and stone composite decorative board comprises a stone board which has an even fiber glass web with thickness of 0.4 mm to 1.3 mm adhered to its backside, and the preferred thickness of the fiber glass web is 1.3 mm.

On the premise that the natural texture and color of the decorative surface are not affected and the weight is reduced, this invention provides a composite structure with an even fiber glass web adhered to the backside of the ultra thin stone board, which not only improves the structure performance of original stone board but also enhances the flexibility, intensity and the impact resistance performance. It has notable advantage which is the resistance to the destructive pressure of wind to decorative surface of the external wall of high building. The significance of the invention is saving the nature resource, lightening the labor intensity, increasing the production rate, reducing the cost of production, and so on.

### BRIEF DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1 is a cross-sectional view of an embodiment of the present disclosure.

### DETAILED DESCRIPTION

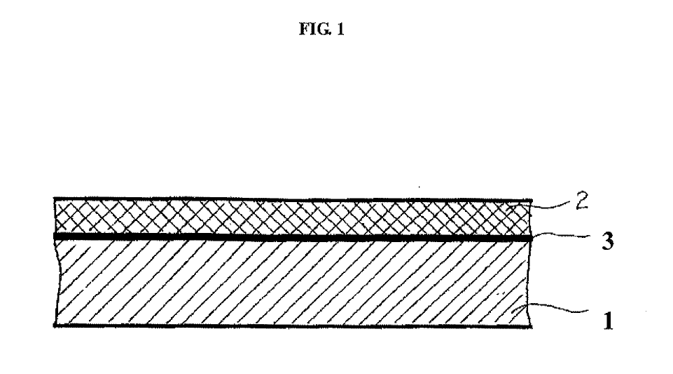

As shown in FIG. 1, a fiber glass and stone composite decorative board of the invention comprises a stone board 1, an adhesive layer 3 and a layer of fiber glass web 2. The fiber glass web 2 with thickness of 1.3 mm adheres to the backside of the stone board 1, and the adhesive layer 3 is a A-B type inorganic adhesive with stable character.

A specific embodiment of the present invention has been disclosed; however, any variations of the disclosed embodiment could be envisioned as within the scope of this invention. It is to be understood that the present invention is not limited to the embodiments described above, but encompasses any and all embodiments within the scope of the following claims.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A fiber glass and stone composite decorative board, comprising a stone board, characterized in that the said stone board has an even fiber glass web adhered to its backside.

2. The fiber glass and stone composite decorative board according to claim 1, characterized in that the said fiber glass web's thickness is 0.4 mm to 1.3 mm.

3. The fiber glass and stone composite decorative board according to claim 2, characterized in that the said fiber glass web's preferred thickness is 1.3 mm.
